(19) United States
(12) Patent Application Publication
(10) Pub. No.: US 2020/0104193 A1
(43) Pub. Date: Apr. 2, 2020

(54) Port Groups

(71) Applicant: Apple Inc., Cupertino, CA (US)

(72) Inventors: Sunil Kittur, Kanata (CA); Dino R. Canton, Nepean (CA); Shawn R. Woodtke, Richmond (CA); Aleksandar Ristovski, Ottawa (CA)

(21) Appl. No.: 16/564,217

(22) Filed: Sep. 9, 2019

Related U.S. Application Data
(60) Provisional application No. 62/738,491, filed on Sep. 28, 2018.

(51) Int. Cl. G06F 9/54

(52) U.S. Cl. CPC G06F 9/542; G06F 9/546

(57) ABSTRACT

In an embodiment, an operating system provides a port group service that permits two or more ports to be bound together as a port group. A thread may listen for messages and/or events on the port group, and thus may receive a message/event from any of the ports in the port group and may process that message/event. Threads that send messages/events (“sending threads”) may send a message/event to a port in the port group, and the messages/events received on the various ports may be processed according to a queue policy for the ports in the port group. Messages/events may be transmitted to from the ports to a listening thread (a “receiving thread”) using a receive policy that determines the priority at which the receiving thread is to execute to process the message/event.

This application claims benefit of priority to U.S. Provisional Patent Application Ser. No. 62/738,491, filed on Sep. 28, 2018. The above application is incorporated herein by reference in its entirety. To the extent that any material in the above application conflicts with material expressly set forth herein, the material expressly set forth herein controls.

### BACKGROUND

### Technical Field

Embodiments described herein are related to an operating system and, more particularly, ports for threads in an operating system.

### Description of the Related Art

Processor-based electronic systems (e.g. computer systems, whether stand alone or incorporated into another product) typically include controlling code that controls access to system resources by other code executing on the system, so that the resources can be used in a conflict-free fashion that permits the other code to execute correctly and with acceptable performance. The controlling code is typically referred to as an operating system, and the other code is typically referred to as application programs or the like. System resources include memory, peripheral devices, services implemented by the operating system, etc.

The operating system and/or the application programs can be thread-based, in which one or more threads execute on the processors to implement the functionality of the operating system/program. A given program can be single-threaded (only one thread implements the program) or multi-threaded (multiple threads cooperate to implement the program).

The threads in the system communicate with each other so that the application programs can request resources from the operating system, return resources that are no longer in use by the application program, etc. One mechanism for communication among the threads is the port. A port can be used to transmit a message from a source thread for a particular resource or service. The message can be processed by any thread that is “listening” to the port (i.e. the thread attempts to read messages from the port, either by making a call to the port and blocking until a message arrives or periodically attempting to obtain a message from the port). The message can be a synchronous message, in which the receiving thread replies to the sending thread when processing is complete. For a synchronous message, the sending thread is normally blocked waiting for the response to the message. The message can also be an asynchronous message in which the requested service can be performed at any point and the sending thread is not waiting for a response. Asynchronous messages are referred to as events in this description. While the port mechanism is useful, it can be cumbersome for some threads that listen for messages on multiple ports.

### SUMMARY

In an embodiment, an operating system provides a port group service that permits two or more ports to be bound together as a port group. A thread may listen for messages and/or events on the port group, and thus may receive a message/event from any of the ports in the port group and may process that message/event. Threads that send messages/events (“sending threads”) may send a message/event to a port in the port group, and the messages/events received on the various ports may be processed according to a queue policy for the ports in the port group. Messages/events may be transmitted from the ports to a listening thread (a “receiving thread”) using a receive policy that determines the priority at which the receiving thread is to execute to process the message/event. The port group may provide a convenient mechanism for receiving threads to process messages/events multiple ports, in an embodiment. An embodiment of the port group may provide mechanisms to improve processing performance and balancing of loads for messages/events on multiple ports.

### BRIEF DESCRIPTION OF THE DRAWINGS

The following detailed description makes reference to the accompanying drawings, which are now briefly described.

FIG. 1 is a block diagram of one embodiment of an operating system having a port group service.

FIG. 2 is a block diagram of one embodiment of a port group.

FIG. 3 is a table illustrating attributes of one embodiment of ports and the port group.

FIG. 4 is a flowchart illustrating operation of one embodiment of the port group service in response to a sending thread delivering a message/event on a port in a port group.

FIG. 5 is a flowchart illustrating operation of one embodiment of the port group service in response to a request from a receiving thread.

FIG. 6 is a flowchart illustrating operation of one embodiment of the port group service in response to a receiving thread completing processing of a message from the port group.

FIG. 7 is a block diagram of one embodiment of a computer system.

FIG. 8 is a block diagram of one embodiment of a computer accessible storage medium.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used herein, the terms “first,” “second,” etc. are used as labels for nouns that they precede, and do not imply any type of ordering (e.g., spatial, temporal, logical, etc.) unless specifically stated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible. In general, the circuitry that forms the structure corresponding to “configured to” may include hardware circuits. The hardware circuits may include any combination of combinatorial logic circuitry, clocked storage devices such as flops, registers, latches, etc., finite state machines, memory such as static random access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims a unit/circuit/component or other structure that is configured to perform one or more tasks is expressly intended not to invoke 35 U.S.C. § 112(f) interpretation for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

As used herein, the term “based on” or “dependent on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

### DETAILED DESCRIPTION OF EMBODIMENTS

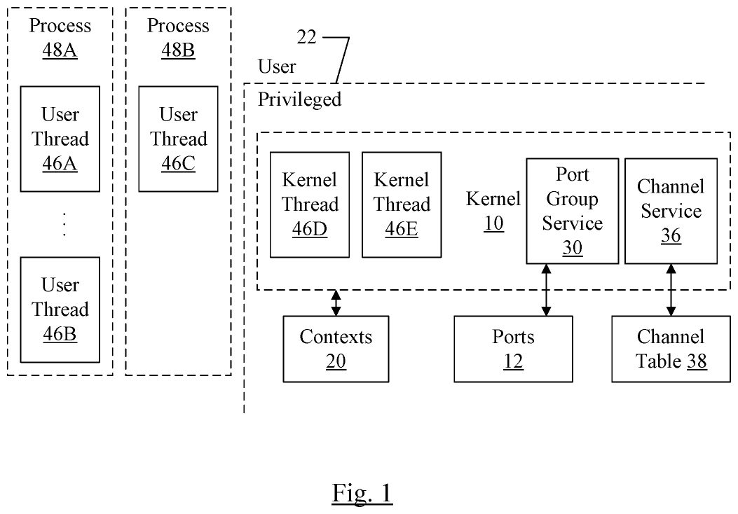

Turning now to FIG. 1, a block diagram of one embodiment of an operating system and related data structures is shown. In the illustrated embodiment, the operating system includes a kernel 10, a set of ports 12, a set of contexts 20, and a channel table 38. The kernel 10 may maintain the one or more contexts 20, which may include contexts for the user threads 46A-46C and/or the user processes 48A-48B. The kernel 10, in the embodiment of FIG. 1, may include a channel service 36 and a port group service 30. The kernel 10 may also include one or more other kernel threads 46D-46E. The channel service 36 and/or the port group service 30 may include one or more kernel threads as well.

A thread may be the smallest granule of instruction code that may be scheduled for execution in the system. Generally, a process includes at least one thread, and may include multiple threads. A process may be an instance of a running program. The discussion herein may refer to threads for simplicity, but may equally apply to a single threaded or multi-threaded process or program. Similarly, the discussion may refer to processes, but may equally apply to a thread in a multi-threaded process.

The threads 46A-46E may intercommunicate using ports 12. Each port 12 may have a defined operation associated with it. For example, in an embodiment, kernel 10 may employ a capability-based operating system. Each port 12 may be a capability, and thus a message/event sent to a port may be a request for execution of the corresponding capability. Other embodiments may not be capability-based. In such cases, each port may be defined to implement a given service, allocate a given resource, etc. The threads 46A-46E may transmit a message/event to the port to request the given service, to request allocation of the given resource, etc. A thread 46A-46E that transmits a message/event may be referred to herein as a “sending thread” for that message/event. The sending thread transmitting a message/event may be referred to as delivering a message/event to the port or on the port. Threads 46A-46E may also be processors of messages on ports 12 (“receiving threads” for messages/events on those ports 12). That is, the service or resource allocation may be performed by one or more threads 46A-46E. A given thread 46A-46E may be a sending thread for some messages/events and a receiving thread for other messages/events.

A given process may implement more than one port 12, and/or a thread in the given process may process messages/events from more than one port 12. For example, there may be multiple ports that implement the same service (but access to the different ports 12 may be restricted to certain threads, or a given thread may be assigned one of the multiple ports with which to communicate when the service/resource is desired). There may be multiple ports used as part of a larger service, or to access a service or resource in different ways. A given thread may process messages from any of those ports.

To facilitate the receiving threads that process messages from multiple ports, the kernel 10 may include the port group service 30. The port group service 30 may group related ports into a port group, which may act as an entity from which the receiving thread may request a message/event. For example, the thread may execute a syscall to the port group, which may block the receiving thread until a message/event is available for processing. The message/event may come from any of the ports 12 in the port group.

The port group service 30 may support configurations which control how the messages/events received on the various ports are queued with respect to each other (and thus may affect the order in which messages/events are processed among the messages/events received on the ports in the port group). The port group service 30 may further support an orthogonal mechanism at the port group output (i.e., when a receiving thread attempts to dequeue a message/event) to provide for processing of the various messages/events with certain levels of quality of service.

The channel service 36 may be responsible for creating and maintaining channels between threads and ports/port groups. Channels may be the communication mechanism between threads and ports. In an embodiment, a port may create a channel on which threads may send messages/events. The channel service 36 may create the channel, and may provide an identifier (a channel identifier, or Cid). The Cid may be unique among the Cids assigned by the channel service 36, and thus may identify the corresponding channel unambiguously. The port may provide the Cid (or “vend” the Cid) to another thread or threads, permitting those threads to deliver a message on the port. In an embodiment, the port may also assign a token (or “cookie”) to the channel, which may be used by the port to verify that the message comes from a permitted thread. That is, the token may verify that the message is being received from a thread to which the channel-owning thread gave the Cid (or another thread to which the permitted thread passed the Cid). In an embodiment, the token may be inaccessible to the threads to which the Cid is passed, and thus may be unforgeable. For example, the token may be maintained by the channel service 36 and may be inserted into the message when a thread transmits the message on a channel. Alternatively, the token may be encrypted or otherwise hidden from the thread that uses the channel.

The channel service 36 may track various channels that have been created in the channel table 38. The channel table 38 may have any format that permits the channel service 36 to identify Cids and the threads to which they belong. When a message having a given Cid is received from a thread, the channel service 36 may identify the targeted port via the Cid and may pass the message to the targeted port.

The dotted line 22 divides the portion of the software that operates in user mode (or space) and the portion that operates in privileged mode/space. As can be seen in FIG. 1, the kernel 10 is the only portion of the system that executes in the privileged mode in this embodiment. Privileged mode may refer to a processor mode (in the processor executing the corresponding code) in which access to protected resources is permissible (e.g. control registers of the processor that control various processor features, certain instructions which access the protected resources may be executed without causing an exception, etc.). In the user mode, the processor restricts access to the protected resources and attempts by the code being executed to change the protected resources may result in an exception. Read access to the protected resources may not be permitted as well, in some cases, and attempts by the code to read such resources may similarly result in an exception.

The contexts 20 may be the data which the processor uses to resume executing a given code sequence. It may include settings for certain privileged registers, a copy of the user registers, etc., depending on the instruction set architecture implemented by the processor. Thus, each thread/process may have a context (or may have one created for it by the kernel 10). The kernel 10 itself may also have a context 20.

The operating system may be used in any type of computing system, such as mobile systems (laptops, smart phones, tablets, etc.), desktop or server systems, and/or embedded systems. For example, the operating system may be in a computing system that is embedded in the product. In one particular case, the product may be a motor vehicle and the embedded computing system may provide one or more automated driving features. In some embodiments, the automated driving features may automate any portion of driving, up to and including fully automated driving in at least one embodiment, in which the human driver is eliminated.

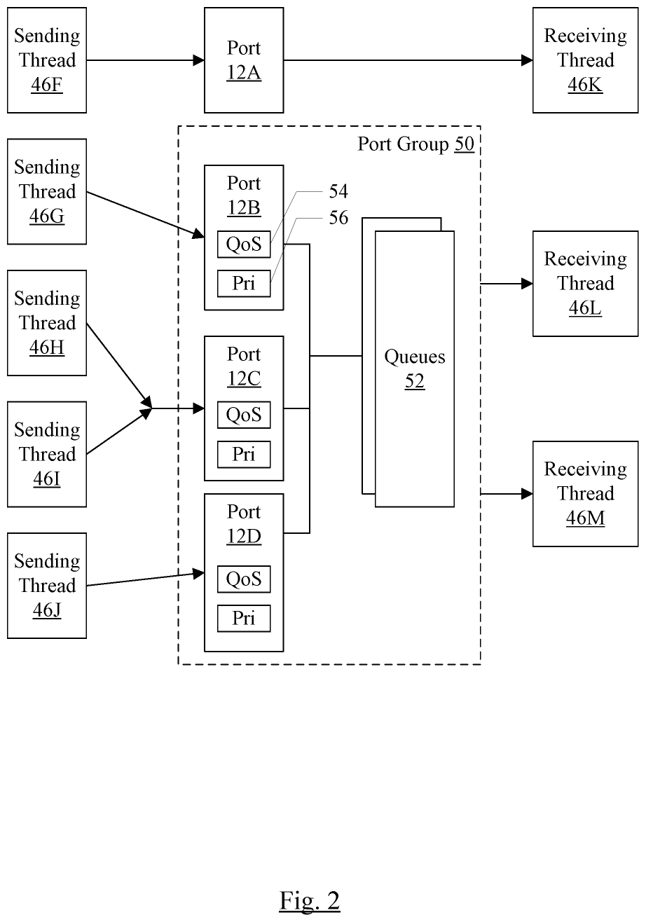

FIG. 2 is a block diagram illustrating one embodiment of a port group 50 formed from ports 12B, 12C, and 12D, for example. A port group may generally include at least two ports, but may include more than two ports as desired in a given system. In an embodiment, a port group having only one port (or even zero ports) may be supported as well. The port group 50 also includes one or more queues 52 into which messages/events received on the ports 12B-12D are queued based on the QoS configuration of the ports 12B-12D. The QoS configuration is shown as the QoS block in each port 12B-12D, e.g. reference numeral 54 for port 12B. Each port may also include a priority assigned to that port, shown as the “Pri block” in each port 12B-12D, e.g. reference numeral 56 for port 12B. In addition to port groups such as port group 50, individual ports may also be supported such as the port 12A shown in FIG. 2.

FIG. 2 illustrates sending threads 46F-46J and receiving threads 46K-46M. The threads 46A-46E shown in FIG. 1 may be examples of one or both of the sending threads 46F-46J and the receiving threads 46K-46M. A given thread may be both a sending thread for one port/port group and a receiving thread for another port group. The sending thread 46F sends/delivers to the port 12A, from which the receiving thread 46K receives. The sending thread 46G sends/delivers to the port 12B, whereas the sending threads 46H-46I send/deliver to the port 12C and the sending thread 46J sends/delivers to the port 12D. The channels mentioned previously are illustrated by the arrows between sending threads/receiving threads and ports or port groups. A given channel may be shared (e.g. the channel to the port 12C in FIG. 2 is shared by the sending threads 48H-48I). Alternatively, separate channels may be used by sending threads to transmit to the same port.

While the receiving thread 46K receives directly from the port 12A, the receiving threads 46L and 46M receive from the port group 50. Thus, the channels from the port group 50 are shown emanating from port group 50 instead of an individual port 12B-12D. The receiving threads 46L-46M may attempt to receive a message/event from the port group 50 (also referred to as dequeuing the message/event, since the message/event is removed from the queues 52). The message/event received by the receiving thread 46L-46M may have been sent by any of the sending threads 46G-46J through any of the ports 12B-12D. Two consecutive messages/events received by a given receiving thread 46L-46M may have been received from different sending threads 46G-46J on different ports 12B-12D.

The QoS may include at least two orthogonal attributes: the queue policy and the receive policy. The queue policy may control the queuing of messages/events delivered by sending threads on the ports 12B-12D in the queues 52. For example, in one embodiment, the queue policy may be first in, first out (FIFO) or priority. The FIFO queue policy may cause the messages delivered on the corresponding port 12B-12D to be queued in FIFO order in the queues 52. Viewed in another way, the FIFO queue policy may enqueue messages/events at a static/fixed priority as compared to the other ports in the port group. Thus, each message/event delivered to a port having the FIFO queue policy may be processed in FIFO order with respect to other messages/events received on that port, and the priority of the messages/events compared to messages/events from other ports may be based on the relative priority of the FIFO port and the other ports. The priority policy may enqueue a received message/event based on the priority of the sending thread 46G-46J. That is, the sending thread's priority may be compared to the priorities of the sending threads for messages/event already in the queues 52 to find a location in which to insert the message. In one embodiment, a port group 50 may employ a single priority queue 52 into which messages/events may be queued and from which messages/events may be dequeued, and the FIFO ports may be managed as discussed above with respect to other ports. Alternatively, several queues 52 that store messages/events of different priority ranges may be supported, and the received message/event may be enqueued in the queue having the priority range that includes the sending thread's priority. For messages/events at the same priority or priority range, FIFO order may be used. In other embodiments, other queue policies may be used to manage processing between a FIFO queue policy and the priority queue policy. In some embodiments, one or more other queue policies may be used in addition to, or as substitutes for, the priority and FIFO policies as the queue policies supported for a port group.

The receive policy may control the priority at which the receiving thread executes while processing the message/event. In one embodiment, the receive policy may be natural, fixed, or inherit. With the natural policy, the receiving thread executes at its current priority (that is, the priority of the receiving thread 46L-46M is unchanged when processing the message/event). The current priority of the receiving thread 46L-46M may be the priority that was assigned to the receiving thread 46L-46M when it was launched, a subsequently-assigned priority if the priority is explicitly changed subsequent to launch, a temporarily modified priority due to priority inheritance for another message that the receiving thread 46L-46M has not yet replied to or due to the receiving thread 46L-46M holding a mutex lock that has a higher priority, etc. The fixed policy may cause the receiving thread 46L-46M to execute at the priority assigned to the port 12B-12D (e.g. the priority 56 for the port 12B). The inherit policy may cause the receiving thread 46L-46M to use the priority of the sending thread.

The priority at which a thread executes may affect the scheduling of the thread. The threads may be executed by processors in the system, and there may be more threads than processors. Accordingly, the threads are scheduled for execution. Higher priority threads may be scheduled more frequently and/or may be permitted to run for longer periods of time each time there are scheduled, as compared to lower priority threads. Therefore, higher priority threads may often complete a given amount of processing more rapidly (i.e. at higher performance) than a lower priority thread may complete the given amount of processing.

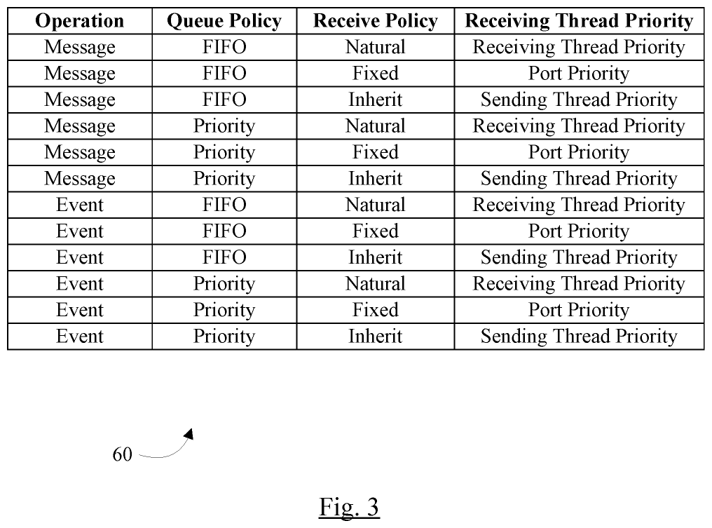

FIG. 3 is a table 60 illustrating the queue policies, receive policies, and corresponding priorities that result from the receive policies for one embodiment. The operation may be similar for messages and events. The message/event may have a FIFO queue policy or a priority queue policy. The queue policy may control insertion of the message/event in the queues 52, but may not impact the priority at which the receiving thread executes when processing the message/event. As mentioned previously, the receiving thread may execute at its own priority if the natural receive policy is specified; the port priority of the receiving port if the fixed priority is specified; and the priority of the sending thread if the inherit priority is specified.

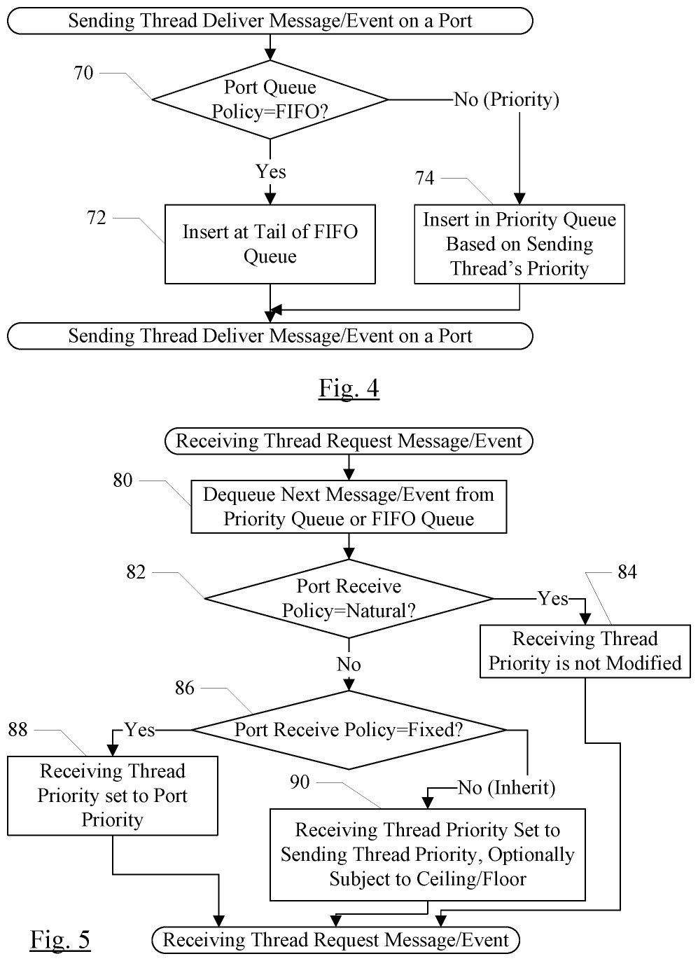

FIG. 4 is a flowchart illustrating operation of one embodiment of the port group service 30 in response to sending thread delivering a message/event on a port in the port group 50. While the blocks are shown in a particular order for ease of understanding, other orders may be used. The port group service 30 may include instructions which, when executed on a computer, cause the computer to perform the operation described. That is, the instructions, when executed, implement the described operation.

The port group service 30 may check the queue policy for the port on which the message/event is delivered. If the queue policy is FIFO (decision block 70, “yes” leg), the port group service 30 may insert that message/event at the tail of the FIFO queue in the queues 52 (block 72). If the queue policy is not FIFO (decision block 70, “no” leg), the queue policy is priority in this embodiment. In this case, the port group service 30 may insert the message/event into a priority queue in the queues 52. The insertion point may be determined by comparing the sending thread's priority to the priorities of the messages/events already enqueued in the priority queue. The sending thread's priority may also be recorded in the priority queue for comparison to subsequently received messages/events. If messages/events already enqueued in the priority queue have the same priority as the newly-received message/event, the newly-received message/event may be inserted in FIFO order behind the previously-received messages/events. In this fashion, priority-queued events may be processed in priority order and FIFO-queued events may be processed in the order received.

FIG. 5 is a flowchart illustrating operation of one embodiment of the port group service 30 in response to a receiving thread on the port group 50 attempting to receive a message/event from the port group 50. The operation of FIG. 5 may occur in response to a receiving thread attempting to receive a message/event or, in the case that there were no messages/events to be processed when a receiving thread attempted to receive a message/event (and blocked), the operation may occur when a message/event is enqueued. While the blocks are shown in a particular order for ease of understanding, other orders may be used. The port group service 30 may include instructions which, when executed on a computer, cause the computer to perform the operation described. That is, the instructions, when executed, implement the described operation.

The port group service 30 may select the next message/event from the queues 52 and may dequeue the message (block 80). The highest priority message in the queues 52 may be dequeued, and may have been delivered to any of the ports in the port group 50. The port group service 30 may check the receive policy associated with the message/event (e.g. as set based on the QoS configuration of the port from which the message/event was received, or based on a QoS configuration for the port group 50 as a whole). If the port receive policy is natural (decision block 82, “yes” leg), the priority of the receiving thread is not modified and the receiving thread processes the message/event at its normal priority (block 84). If the receiving thread most recently processed an event, its priority may not currently be set to its natural priority, in which case the receiving thread's priority would be changed back to its natural priority at block 84. If the port receive policy is fixed (decision block 86, “yes” leg, the receiving thread may have its priority set to the priority of the port 12B-12D on which the message/event was received (block 88). If the port receive policy is not natural or fixed (decision blocks 82 and 86, “no” legs), the receive policy is inherit in this embodiment. Accordingly the receiving thread's priority may be set to the sending thread's priority (block 90).

Optionally, with the inherit policy, a ceiling or floor for the priority of the receiving thread may be applied. If the priority of the thread were allowed to be too low, the performance or throughput of the thread may be compromised, adversely affecting the overall performance of the system in some cases. By applying a floor that provides acceptable performance, such situations may be avoided. Similarly, in some cases, a receiving thread may be a “high cost” thread that would consume too much processor time/other resources if the priority were allowed to be too high. A ceiling for the priority may be applied to prevent such scenarios.

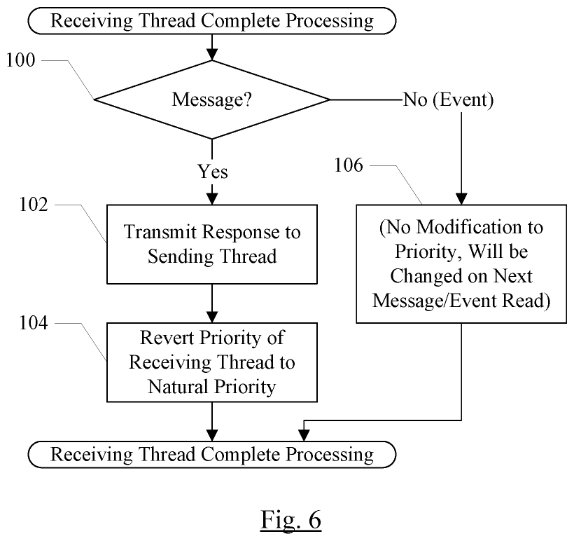

FIG. 6 is a flowchart illustrating operation of one embodiment of a receiving thread that is completing processing of a message/event. While the blocks are shown in a particular order for ease of understanding, other orders may be used. The port group service 30 may include instructions which, when executed on a computer, cause the computer to perform the operation described. That is, the instructions, when executed, implement the described operation.

If the receiving thread is processing a message (decision block 100, “yes” leg), the sending thread may be blocked awaiting a response. The receiving thread may transmit a response to the sending thread (block 102). Additionally, the priority of the receiving thread may revert to its natural priority (block 104). On the other hand, if the receiving thread is processing an event (decision block 100, “no” leg), the sending thread is not blocked awaiting a response. The receiving thread may not send a response, and may not change its priority either. Instead, the priority may be changed on the next message/event read (block 106).

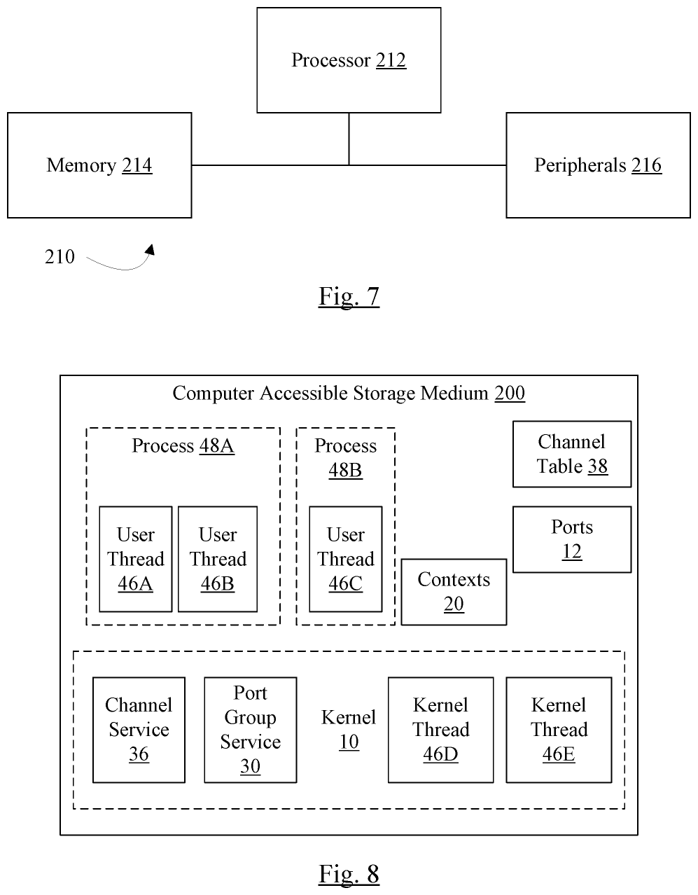

Turning now to FIG. 7, a block diagram of one embodiment of an exemplary computer system 210 is shown. In the embodiment of FIG. 7, the computer system 210 includes at least one processor 212, a memory 214, and various peripheral devices 216. The processor 212 is coupled to the memory 214 and the peripheral devices 216.

The processor 212 is configured to execute instructions, including the instructions in the software described herein such as the kernel 10 (and particularly the port group service 30), user threads, etc. In various embodiments, the processor 212 may implement any desired instruction set (e.g. Intel Architecture-32 (IA-32, also known as x86), IA-32 with 64 bit extensions, x86-64, PowerPC, Sparc, MIPS, ARM, IA-64, etc.). In some embodiments, the computer system 210 may include more than one processor. The processor 212 may be the CPU (or CPUs, if more than one processor is included) in the system 210. The processor 212 may be a multi-core processor, in some embodiments.

The processor 212 may be coupled to the memory 214 and the peripheral devices 216 in any desired fashion. For example, in some embodiments, the processor 212 may be coupled to the memory 214 and/or the peripheral devices 216 via various interconnect. Alternatively or in addition, one or more bridges may be used to couple the processor 212, the memory 214, and the peripheral devices 216.

The memory 214 may comprise any type of memory system. For example, the memory 214 may comprise DRAM, and more particularly double data rate (DDR) SDRAM, RDRAM, etc. A memory controller may be included to interface to the memory 214, and/or the processor 212 may include a memory controller. The memory 214 may store the instructions to be executed by the processor 212 during use, data to be operated upon by the processor 212 during use, etc.

Peripheral devices 216 may represent any sort of hardware devices that may be included in the computer system 210 or coupled thereto (e.g. storage devices, optionally including a computer accessible storage medium 200 such as the one shown in FIG. 8), other input/output (I/O) devices such as video hardware, audio hardware, user interface devices, networking hardware, various sensors, etc.). Peripheral devices 216 may further include various peripheral interfaces and/or bridges to various peripheral interfaces such as peripheral component interconnect (PCI), PCI Express (PCIe), universal serial bus (USB), etc. The interfaces may be industry-standard interfaces and/or proprietary interfaces. In some embodiments, the processor 212, the memory controller for the memory 214, and one or more of the peripheral devices and/or interfaces may be integrated into an integrated circuit (e.g. a system on a chip (SOC)).

The computer system 210 may be any sort of computer system, including general purpose computer systems such as desktops, laptops, servers, etc. The computer system 210 may be a portable system such as a smart phone, personal digital assistant, tablet, etc. The computer system 210 may also be an embedded system for another product.

FIG. 8 is a block diagram of one embodiment of a computer accessible storage medium 200. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 200 may store data in a non-transitory manner, where non-transitory in this context may refer to not transmitting the instructions/data on a signal. For example, non-transitory storage may be volatile (and may lose the stored instructions/data in response to a power down) or non-volatile.

The computer accessible storage medium 200 in FIG. 8 may store code forming the kernel 10, including the port group service 30, the channel service 36, and/or various kernel threads 46D-46E, and/or the user threads 46A-46C in the user processes 48A-48B. The computer accessible storage medium 200 may still further store one or more data structures such as the channel table 38, the ports 12, and/or the contexts 20. The port group service 30, the channel service 36, the kernel threads 46D-46E, the kernel 10, the user threads 46A-46C, and/or the processes 48A-48B may comprise instructions which, when executed, implement the operation described above for these components. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A non-transitory computer accessible storage medium storing a plurality of instructions that are computer-executable to cause the computer to:
receive a message on a first port that is configured into a port group with one or more second ports;
enqueue the message in a queue associated with the port group according to a queue policy associated with the first port, wherein the queue is also used for messages from the one or more second ports;
dequeue the message to a receiving thread based on a receive policy associated with the first port.

2. The non-transitory computer accessible storage medium as recited in claim 1 wherein the queue policy is first in, first out, and wherein messages received on the first port are processed in the order received on the port.

3. The non-transitory computer accessible storage medium as recited in claim 2 wherein a second queue policy associated with at least one of the one or more second ports is priority, and wherein the messages received on the first port are processed with respect to messages received on the at least one of the one or more second ports based on a relative priority of the first port to the at least one of the one or more second ports.

4. The non-transitory computer accessible storage medium as recited in claim 1 wherein the queue policy is priority, and wherein the message is processed with respect to messages received on the one or more other ports based on a relative priority of the first port to the one or more second ports.

5. The non-transitory computer accessible storage medium as recited in claim 4 wherein messages having a same priority are processed in the order the messages are received.

6. The non-transitory computer accessible storage medium as recited in claim 1 wherein the receive policy specifies a priority at which the receiving thread executes to process the message.

7. The non-transitory computer accessible storage medium as recited in claim 6 wherein the receive policy causes the receiving thread to execute at the receiving thread's current priority.

8. The non-transitory computer accessible storage medium as recited in claim 7 wherein the plurality of instructions, when executed, reset the receiving thread's current priority to an initially-assigned priority to process the message.

9. The non-transitory computer accessible storage medium as recited in claim 7 wherein the plurality of instructions, when executed, reset the receiving thread's current priority to an a most-recently changed priority to process the message.

10. The non-transitory computer accessible storage medium as recited in claim 7 wherein the receiving thread's current priority is a temporary priority used for processing a previous message that has not been completed.

11. The non-transitory computer accessible storage medium as recited in claim 6 wherein the receive policy causes the receiving thread to execute at a priority assigned to the first port.

12. The non-transitory computer accessible storage medium as recited in claim 6 wherein the receive policy causes the receiving thread to execute at a priority assigned to a source thread that transmitted the message to the first port.

13. The non-transitory computer accessible storage medium as recited in claim 12 wherein the port group further supports a ceiling that limits the priority to now more than a maximum priority.

14. The non-transitory computer accessible storage medium as recited in claim 12 wherein the port group further supports a floor that limits the priority to no less than a minimum priority.

15. A computer system comprising:
one or more processors; and
a non-transitory computer accessible storage medium storing a plurality of instructions that are executable on the one or more processors to cause the computer system to:
receive a message on a first port that is configured into a port group with one or more second ports;
enqueue the message in a queue associated with the port group according to a queue policy associated with the first port, wherein the queue is also used for messages from the one or more second ports;
dequeue the message to a receiving thread based on a receive policy associated with the first port.

16. The computer system as recited in claim 15 wherein the one or more processors execute the receiving thread.

17. The computer system as recited in claim 15 wherein the one or more processors execute a source thread that transmits the message to the first port.

18. A method comprising:
receiving a message on a first port that is configured into a port group with one or more second ports in a computer system;
enqueuing the message in a queue associated with the port group according to a queue policy associated with the first port, wherein the queue is also used for messages from the one or more second ports;
dequeuing the message to a receiving thread based on a receive policy associated with the first port.

19. The method as recited in claim 18 wherein the queue policy is first in, first out.

20. The method as recited in claim 18 wherein the queue policy is priority.

21. The method as recited in claim 18 wherein the receive policy specifies a priority at which the receiving thread executes to process the message.
